(19) United States
(12) Patent Application Publication
(10) Pub. No.: US 2015/0348037 A1
(43) Pub. Date: Dec. 3, 2015

(54) METHOD AND SYSTEM FOR IMPROVED FRAUD SCORING BASED ON CRIMINAL ACTIVITY

(71) Applicant: MasterCard International Incorporated, Purchase, NY (US)

(72) Inventors: Kenneth UNSER, Fairfield, CT (US); Kent Olof Niklas BERNTSSON, Rye, NY (US); Jean-Pierre GERARD, Croton-On-Hudson, NY (US)

(73) Assignee: MasterCard International Incorporated, Purchase, NY (US)

(21) Appl. No.: 14/293,245

(22) Filed: Jun. 2, 2014

(51) Int. Cl. G06Q 20/40

(52) U.S. Cl. CPC G06Q 20/4014

(57) ABSTRACT

A method for improving fraud scoring based on criminal activity includes: storing transaction data entries, each including transaction data related to a payment transaction and a transacting consumer identifier; storing consumer profiles, each including data related to consumers including consumer characteristics and a consumer identifier; storing fraud scoring rules, each being configured to score a payment transaction for a likelihood of fraud based on transaction data; receiving a criminal activity notification, the notification including criminal characteristics associated with criminals or victims associated with untrustworthiness or fraud; identifying a specific consumer profile where a predefined number of the consumer characteristics correspond to the criminal characteristics; identifying a subset of transaction data entries where the transacting consumer identifier corresponds to the consumer identifier in the specific consumer profile; and updating the fraud scoring rules based on the transaction data included in each transaction data entry in the subset.

### FIELD

The present disclosure relates to the improving of fraud scoring based on criminal activity, specifically the use of transaction data corresponding to criminals or victims associated with untrustworthiness or fraud to improve fraud scoring rules.

### BACKGROUND

Fraud scoring is used by payment networks, merchant acquirers, payment card issuers, and other entities to score payment transactions for a likelihood of fraud. Based on the score calculated for a transaction, entities may respond differently to the transaction, such as by denying the transaction, requiring additional authentication of the consumer and/or merchant involved, processing the transaction using a different method, or other actions. However, even despite such methods, fraudulent transactions continue to cost consumers, issuers, acquirers, merchants, payment networks, and others a significant amount of money each year.

In addition to entities involved in the payment transactions themselves, law enforcement may often be involved in the investigation into fraudulent transactions. In many instances, fraudulent transactions may be a crime themselves or otherwise indicative of a crime being or having been committed, such as identity theft. Information regarding account holders that have been found as committing fraud, or that have been a victim of fraud, may be beneficial in updating fraud scoring models to improve accuracy and effectiveness. However, in many instances, detailed information regarding a criminal or victim associated with fraud suitable for identifying a corresponding account may be unavailable. In addition, victims of fraud may find a direct identification of their account to be a violation of their privacy, particularly if a privacy violation led to their position as a victim of a fraudster.

Thus, there is a need for a technical solution to improve fraud scoring based on criminal activity, while maintaining consumer privacy.

### SUMMARY

The present disclosure provides a description of systems and methods for improving fraud scoring based on criminal activity.

A method for improving fraud scoring based on criminal activity includes: storing, in a transaction database, a plurality of transaction data entries, wherein each transaction data entry includes data related to a payment transaction including at least a transacting consumer identifier associated with a consumer involved in the related payment transaction and transaction data; storing, in a profile database, a plurality of consumer profiles, wherein each consumer profile includes data related to one or more consumers including at least a plurality of consumer characteristics associated with each of the related one or more consumers and at least one consumer identifier, each of the at least one consumer identifier being associated at least one of the related one or more consumers; storing, in a rules database, one or more fraud scoring rules, wherein each of the one or more fraud scoring rules are configured to score a payment transaction for a likelihood of fraud based on at least transaction data associated with the payment transaction; receiving, by a receiving device, a criminal activity notification, wherein the criminal activity notification includes at least a plurality of criminal characteristics associated with one or more criminals or victims associated with untrustworthiness or fraud; identifying, in the profile database, a specific consumer profile where at least a predefined number of the included plurality of consumer characteristics correspond to the plurality of criminal characteristics; identifying, in the transaction database, a subset of the plurality of transaction data entries where the included transacting consumer identifier corresponds to at least one of each of the at least one consumer identifier included in the identified specific consumer profile; and updating, in the rules database, the one or more fraud scoring rules based on at least the transaction data included in each transaction data entry in the identified subset of transaction data entries.

A system for improving fraud scoring based on criminal activity includes a transaction database, a profile database, a rules database, a receiving device, and a processing device. The transaction database is configured to store a plurality of transaction data entries, wherein each transaction data entry includes data related to a payment transaction including at least a transacting consumer identifier associated with a consumer involved in the related payment transaction and transaction data. The profile database is configured to store a plurality of consumer profiles, wherein each consumer profile includes data related to one or more consumers including at least a plurality of consumer characteristics associated with each of the related one or more consumers and at least one consumer identifier, each of the at least one consumer identifier being associated at least one of the related one or more consumers. The rules database is configured to store one or more fraud scoring rules, wherein each of the one or more fraud scoring rules are configured to score a payment transaction for a likelihood of fraud based on at least transaction data associated with the payment transaction. The receiving device is configured to receive a criminal activity notification, wherein the criminal activity notification includes at least a plurality of criminal characteristics associated with one or more criminals or victims associated with untrustworthiness or fraud. The processing device is configured to: identify, in the profile database, a specific consumer profile where at least a predefined number of the included plurality of consumer characteristics correspond to the plurality of criminal characteristics; identify, in the transaction database, a subset of the plurality of transaction data entries where the included transacting consumer identifier corresponds to at least one of each of the at least one consumer identifier included in the identified specific consumer profile; and update, in the rules database, the one or more fraud scoring rules based on at least the transaction data included in each transaction data entry in the identified subset of transaction data entries.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the improving of fraud scoring based on criminal activity in accordance with exemplary embodiments.

FIG. 2 is a block diagram illustrating the processing server of FIG. 1 for the improving of fraud scoring based on criminal activity in accordance with exemplary embodiments.

FIGS. 3A and 3B are flow diagrams illustrating a process for the improving of fraud scoring rules based on criminal activity while maintaining consumer privacy in accordance with exemplary embodiments.

FIG. 4 is a flow chart illustrating a process for improving fraud scoring based on criminal activity using the processing server of FIG. 2 in accordance with exemplary embodiments.

FIG. 5 is a flow chart illustrating an exemplary method for improving fraud scoring based on criminal activity in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Personally identifiable information (PII)—PII may include information that may be used, alone or in conjunction with other sources, to uniquely identify a single individual. Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc. The present disclosure provides for methods and systems where the processing server 104 does not possess any personally identifiable information. Systems and methods apparent to persons having skill in the art for rendering potentially personally identifiable information anonymous may be used, such as bucketing. Bucketing may include aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers and thus no longer be personally identifiable to that consumer. In other embodiments, encryption may be used. For example, personally identifiable information (e.g., an account number) may be encrypted (e.g., using a one-way encryption) such that the processing server 104 may not possess the PII or be able to decrypt the encrypted PII.

### System for Improving Fraud Scoring Based on Criminal Activity

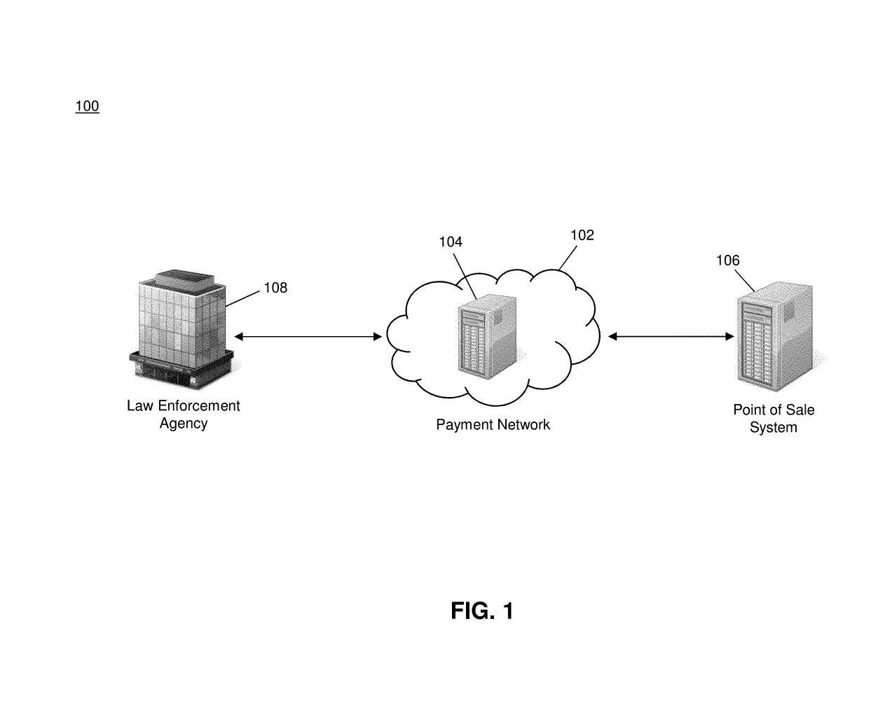

FIG. 1 illustrates a system 100 for the improving of fraud scoring based on criminal activity while maintaining consumer privacy.

The system 100 may include a payment network 102. The payment network 102 may be configured to process payment transactions using traditional methods and systems that will be apparent to persons having skill in the relevant art. As part of the processing of payment transactions, the payment network 102 may score payment transactions using one or more fraud scoring rules. In some instances, the transactions may be processed differently based on a calculated fraud score using the one or more fraud scoring rules. In other instances, calculated fraud scores may be included in transaction data forwarded to issuers or other financial institutions involved in the processing of the payment transaction.

The payment network 102 may include a processing server 104. The processing server 104, as discussed in more detail below, may be a computing device configured to improve fraud scoring rules used to score payment transactions based on criminal activity. As discussed in more detail below, the processing server 104 may store account profiles for a plurality of consumer accounts. The processing server 104 may also store transaction data for a plurality of payment transactions.

Transaction data may be received from the payment network 102. For example, the payment network 102 may process a payment transaction based on an authorization request originating from a point of sale system 106. As part of the transaction processing, such as during the authorization process or once the processing has been completed, the payment network 102 may provide transaction data for the payment transaction to the processing server 104. In some embodiments, the processing server 104 may process the payment transaction for the payment network 102, and may store the transaction data received during the processing of the transaction.

The processing server 104 may receive data regarding criminal activity from a law enforcement agency 108 for use in improving fraud scoring rules. The data received from the law enforcement agency 108 may include at least a plurality of demographic characteristics associated with one or more criminals or victims associated with untrustworthiness or fraud. The demographic characteristics may not be personally identifiable to the associated one or more criminals or victims. For example, the demographic characteristics may be bucketed, encrypted, or otherwise obscured such that an associated consumer may not be personally identified using the demographic characteristics.

The processing server 104 may then identify an account profile associated with one or more consumer accounts that includes demographic characteristics that correspond to those received from the law enforcement agency 108. In some instances, the correspondence may be between a predetermined number of the characteristics. In a further instance, the predetermined number may be such that at least a specific number of account profiles are identified as being corresponding to the demographic characteristics, such as to protect consumer privacy. For example, the processing server 104 may identify at least ten account profiles whose demographic characteristics match those received from the law enforcement agency 108.

In some embodiments, account profiles may be associated with a microsegment of consumers to protect consumer privacy. A microsegment of consumers may be a group of consumers that is granular enough to be valuable to advertisers, marketers, offer providers, merchants, retailers, etc., but still maintain a high level of consumer privacy without the use or obtaining of personally identifiable information. Microsegments may be defined based on geographical or demographical information, such as age, gender, income, marital status, postal code, income, spending propensity, familial status, etc., behavioral variables, or any other suitable type of data, such as discussed herein. For example, a microsegment of consumers may include ten or more consumers that have at least six different demographic characteristics in common. For instance, a group of consumers of the same gender, income range, age range, marital status, postal code, and family size. Additional detail regarding microsegments may be found in U.S. patent application Ser. No. 13/437,987, entitled “Protecting Privacy in Audience Creation,” by Curtis Villars et al., filed on Apr. 3, 2012, which is herein incorporated by reference in its entirety.

Once one or more account profiles have been identified, the processing server 104 may identify transaction data for payment transactions conducted involving the identified account profiles. The processing server 104 may then, as discussed in more detail below, update the fraud scoring rules based on the transaction data.

Methods and systems discussed herein may be suitable for updating fraud scoring rules using transaction data associated with criminals and victims associated with untrustworthiness or fraud while still maintaining a high level of consumer privacy. By identifying transactions for both criminals and victims, the processing server 104 may better identify patterns indicative of fraud and untrustworthiness, such as by analyzing transactions that occur when a victim's account has been compromised, analyzing different transaction behaviors for a criminal once they have stolen a victim's account, etc. By using demographic characteristics, the processing server 104 may be able to use such information to improve fraud scoring, even without detailed consumer information that may be unavailable, and while assuring victims that their privacy is maintained in instances where they may feel vulnerable due to an earlier compromise of their account.

### Processing Server

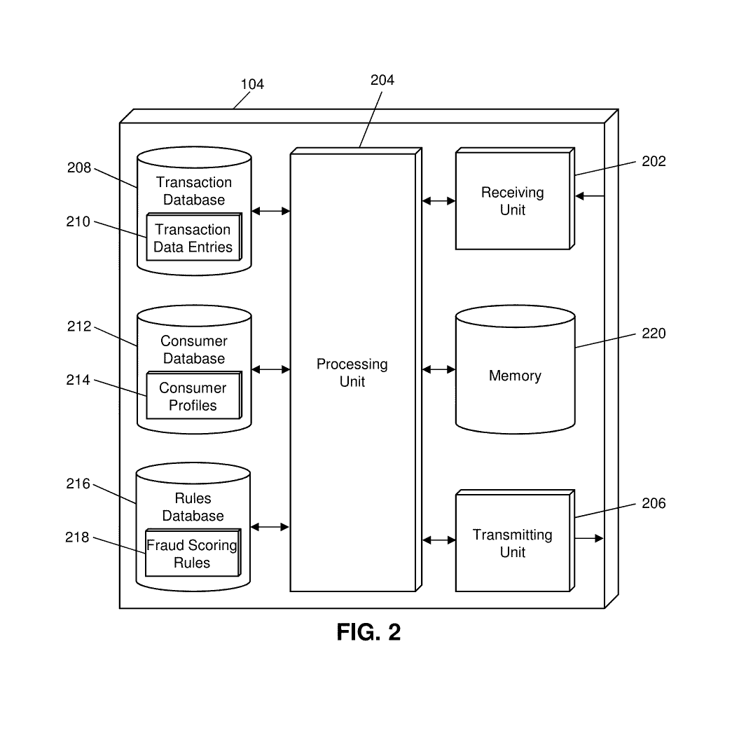

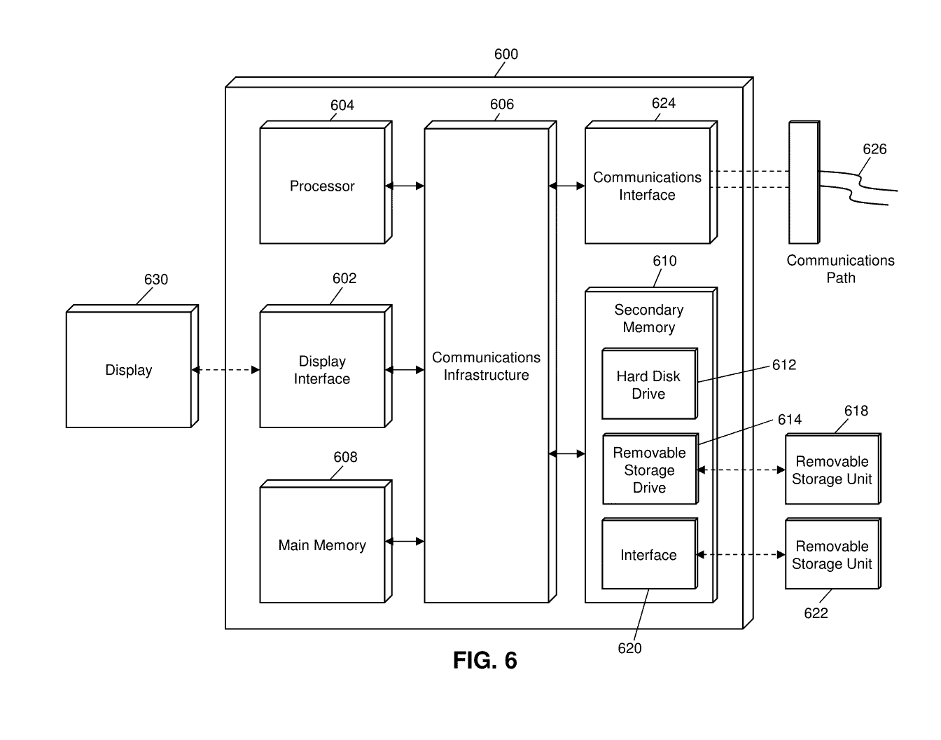

FIG. 2 illustrates an embodiment of the processing server 104 of the system 100. It will be apparent to persons having skill in the relevant art that the embodiment of the processing server 104 illustrated in FIG. 2 is provided as illustration only and may not be exhaustive to all possible configurations of the processing server 104 suitable for performing the functions as discussed herein. For example, the computer system 600 illustrated in FIG. 6 and discussed in more detail below may be a suitable configuration of the processing server 104.

The processing server 104 may include a receiving unit 202. The receiving unit 202 may be configured to receive data over one or more networks via one or more network protocols. The receiving unit 202 may receive transaction data associated with a payment transaction from the payment network 102, point of sale device 106, or other suitable entity or device. The processing server 104 may further include a processing unit 204 configured to perform the functions disclosed herein. The processing unit 204 may store the received transaction data in a transaction database 208 as a plurality of transaction data entries 210.

Each transaction data entry 210 may include data related to a payment transaction including at least a transacting consumer identifier associated with a consumer involved in the related payment transaction and transaction data. The transacting consumer identifier may be a payment account number or other suitable unique value used for identification of the transacting consumer and/or payment account used in the transaction, such as an identification number, username, e-mail address, phone number, etc.

The processing server 104 may also include a consumer database 212. The consumer database 212 may include a plurality of consumer profiles 214. Each consumer profile 214 may include data related to one or more consumers and may include at least a plurality of consumer characteristics associated with each of the related one or more consumers, and at least one consumer identifier. Each consumer identifier may be associated with one or more of the related one or more consumers. The consumer identifier may be a payment account number or other suitable value, that may correspond to the transacting consumer identifier used in one or more payment transactions involving the related one or more consumers. In some embodiments, each consumer profile 214 may be associated with a microsegment of consumers.

The plurality of consumer characteristics may be demographic characteristics or other suitable types of characteristics associated with the related one or more consumers. For example, the consumer characteristics may include age, gender, income, residential status, familial status, marital status, education, occupation, postal code, zip code, spending propensities, trade areas, and more. In exemplary embodiments, the consumer characteristics may not be personally identifiable to any individual consumer. In further embodiments, the consumer characteristics may be associated with at least a minimum number of consumers to maintain a suitable level of consumer privacy.

The processing server 104 may also include a rules database 216. The rules database 216 may include one or more fraud scoring rules 218. Each fraud scoring rule may be configured to score a payment transaction for a likelihood of fraud based on at least transaction data associated with the payment transaction. In some embodiments, fraud scoring rules may also be configured to use consumer account details, merchant account details, location data, and other factors and information that will be apparent to persons having skill in the relevant art to score payment transactions for a likelihood of fraud.

The receiving unit 202 of the processing server 104 may be further configured to receive a criminal activity notification from the law enforcement agency 108. The criminal activity notification may include at least a plurality of criminal characteristics associated with one or more criminals and/or victims associated with untrustworthiness or fraud. The plurality of criminal characteristics may include demographics or other characteristics associated with the one or more criminals and/or victims, such as age, gender, income, residential status, familial status, marital status, education, occupation, postal code, zip code, spending propensities, trade areas, etc.

The processing unit 204 may be configured to identify one or more consumer profiles 214 stored in the consumer database 212 where at least a predetermined number of the included consumer characteristics correspond to the received criminal characteristics. The predetermined number may be such that the number of consumers related to the identified consumer profiles 214 is such that consumer privacy is maintained. The processing unit 204 may be further configured to then identify transaction data entries 210 in the transaction database 208 where the included transacting consumer identifier corresponds to the consumer identifier included in each of the identified consumer profiles 214.

Once the transaction data entries 210 have been identified, the processing unit 204 may update the fraud scoring rules 218 in the rules database 216 based on the transaction data included therein. In some embodiments, the processing server 104 may include a transmitting unit 206. The transmitting unit 206 may be configured to transmit data over one or more networks via one or more network protocols, which may include transmitting the updated fraud scoring rules 218 to the payment network 102 for use in scoring payment transactions using the updated and improved rules.

The processing server 104 may also include a memory 220. The memory 220 may be configured to store data suitable for performing the functions as disclosed herein. For example, the memory 220 may be configured to store one or more algorithms suitable for use in updating the fraud scoring rules 218 based on the transaction data included in the identified transaction data entries 210. In another example, the memory 220 may be configured to store algorithms suitable for bucketing or otherwise rendering potentially personally identifiable information non-personally identifiable.

In some embodiments, the components of the processing server 104 may be further configured to perform functions suitable for the processing of payment transactions for the payment network 102. Such functions will be apparent to persons having skill in the relevant art and may include, for example, the receiving of an authorization request by the receiving unit 202, the scoring of payment transactions using fraud scoring rules 218 by the processing unit 204, the transmitting of fraud scores and transaction data by the transmitting unit 206, etc.

### Process for Improved Fraud Scoring and Transaction Processing

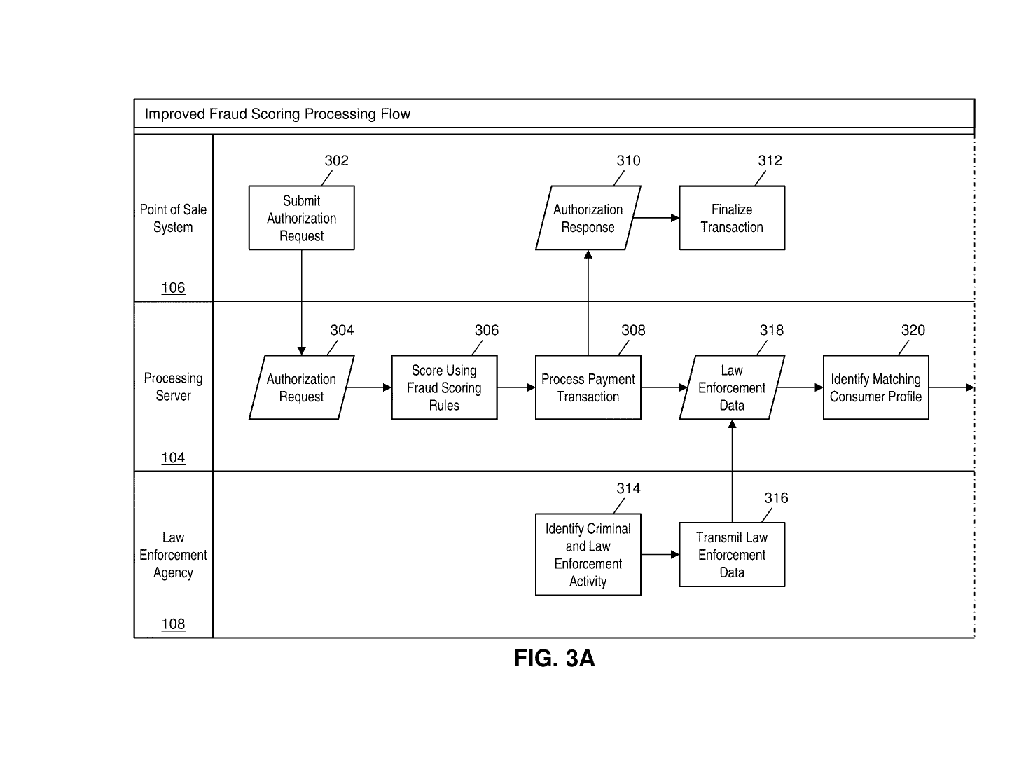

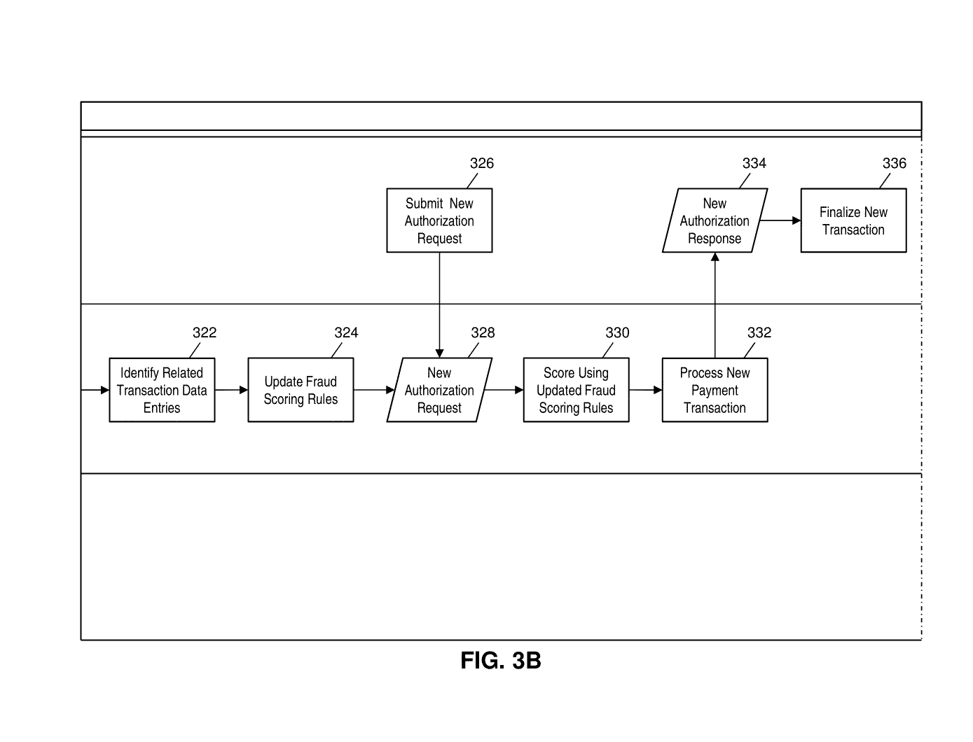

FIGS. 3A and 3B illustrate a processing flow for the improving of fraud scoring based on transaction data and the processing of transactions thereof using the system 100.

In step 302, the point of sale system 106 associated with a merchant may submit an authorization request for a payment transaction to the processing server 104 of the payment network 102. In step 304, the receiving unit 202 of the processing server 104 may receive the authorization request. The authorization request may include at least transaction data for the payment transaction, such as a consumer identifier, merchant data, transaction amount, transaction time and/or date, geographic location, etc.

In step 306, the processing unit 204 of the processing server 104 may score the payment transaction using fraud scoring rules 218 stored in the rules database 216. In step 308, the processing unit 204 may process the payment transaction based on the calculated fraud score using methods and systems that will be apparent to persons having skill in the relevant art. For instance, as part of the processing, the transmitting unit 206 of the processing server 104 may transmit the transaction data and calculated fraud score to an issuer, and the receiving unit 202 may receive a response from the issuer indicating approval or denial of the payment transaction.

In step 310, the point of sale system 106 may receive an authorization response from the processing server 104 as a result of the processing of the payment transaction. The authorization response may indicate approval or denial of the payment transaction. The point of sale system 106 may then, in step 312, finalize the payment transaction, such as by displaying the authorization response to an employee and/or consumer and generating a receipt for the consumer involved in the payment transaction if the payment transaction was approved, or if the payment transaction was denied, displaying such a response to the employee and/or consumer.

In step 314, the law enforcement agency 108 may identify criminal and law enforcement activity that occurs, which may include the identifying of one or more criminals and/or victims associated with untrustworthiness or fraud. For example, the law enforcement agency 108 may identify a criminal convicted of identity theft and one or more victims of the criminal's theft. In step 316, the law enforcement agency 108 may transmit law enforcement data to the processing server 104. The receiving unit 202 may receive the law enforcement data, in step 318. The law enforcement data may include at least a plurality of criminal characteristics associated with the one or more criminals and/or victims associated with untrustworthiness or fraud.

In step 320, the processing unit 204 of the processing server 104 may identify one or more consumer profiles 214 stored in the consumer database 212 that match the received criminal characteristics. A match may be based on a predetermined number of consumer characteristics in each identified consumer profile 214 as corresponding to the received criminal characteristics. In step 322, the processing unit 204 may identify related transaction data entries 210 in the transaction database 208, which may include a transacting consumer identifier that corresponds to a consumer identifier in the identified consumer profiles 214.

In step 324, the processing unit 204 may update the fraud scoring rules 218 in the rules database 216 based on the transaction data in the identified transaction data entries 210. In some instances, the updating of the fraud scoring rules 218 may be further based on the consumer profile 214 associated with each transaction data entry 210. For example, a fraud scoring rule 218 may be updated differently based on transaction data associated with a consumer profile 214 associated with a victim of fraud than transaction data associated with a consumer profile 214 associated with a criminal convicted of fraud.

In step 326, the point of sale system 106 may submit an authorization request for a new payment transaction to the processing server 104. In step 328, the receiving unit 202 may receive the new authorization request. In step 330, the processing unit 204 may score the new payment transaction using the newly-updated fraud scoring rules 218 that have been improved using the transaction data associated with criminals and/or victims associated with untrustworthiness or fraud. In step 332, the processing unit 204 may process the payment transaction, which may include submitting an authorization response for the new transaction to the point of sale system 106. In step 334, the point of sale system 106 may receive the new authorization response, and, in step 336, may finalize the new payment transaction.

### Process for Improving Fraud Scoring Using Transaction Data

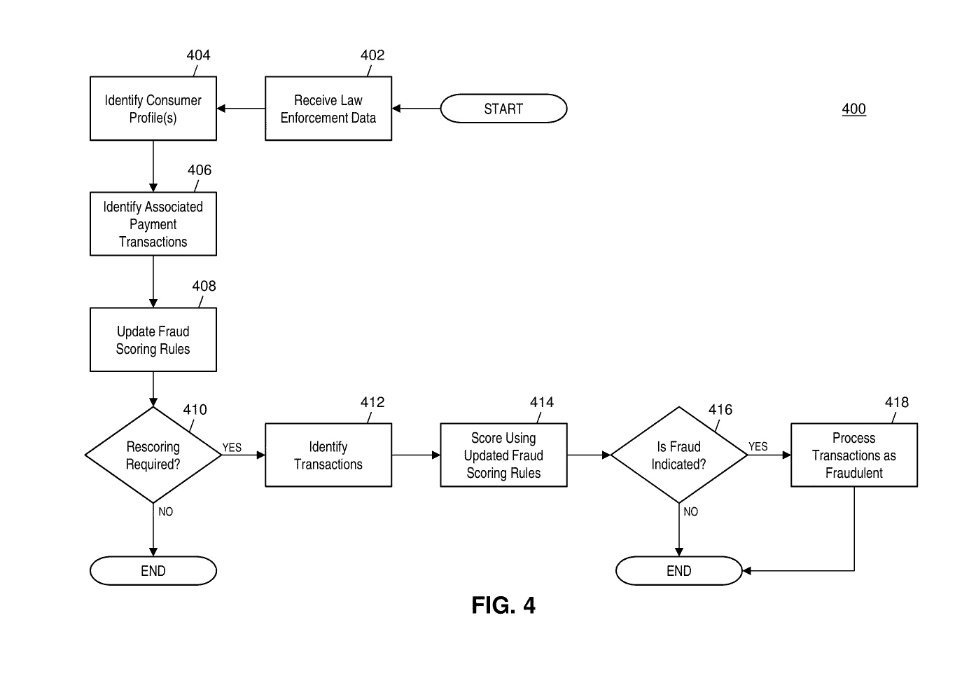

FIG. 4 illustrates a process 400 for the improving of fraud scoring using transaction data associated with one or more criminals or victims associated with untrustworthiness or fraud.

In step 402, the receiving unit 202 of the processing server 104 may receive law enforcement data from the law enforcement agency 108. The law enforcement data may include at least a plurality of criminal characteristics associated with one or more criminals or victims associated with untrustworthiness or fraud. In step 404, the processing unit 204 of the processing server 104 may identify one or more consumer profiles 214 stored in the consumer database 212 of the processing server 104 where at least a predetermined number of the included consumer characteristics correspond to the criminal characteristics included in the received law enforcement data. In some embodiments, the predetermined number of corresponded characteristics and/or the number of identified consumer profiles 214 may be such that a suitable level of privacy of consumers associated with the consumer profiles 214 is maintained.

In step 406, the processing unit 204 may identify transaction data entries 210 stored in the transaction database 208 of the processing server 104 that are associated with the identified one or more consumer profiles 214. Associated transaction data entries 210 may include a transacting consumer identifier that corresponds to a consumer identifier included in one of the identified one or more consumer profiles 214. In step 408, the processing unit 204 may update the fraud scoring rules 218 stored in the rules database 216 of the processing server 104 based on at least the transaction data included in the identified associated transaction data entries 210. In some embodiments, the updating of the fraud scoring rules 218 may be further based on data included in the one or more consumer profiles 214 and/or the received law enforcement data.

In step 410, the processing unit 204 may determine if rescoring of previously scored payment transactions is required. If rescoring is not required, then the process 400 may be completed. If rescoring is required, then, in step 412, the processing unit 204 may identify transactions that are to be rescored. Transactions that are to be rescored may include, for example, transactions that are still being processed, transactions that have not cleared, disputed transactions, and/or other transactions as will be apparent to persons having skill in the relevant art.

In step 414, the processing unit 204 may calculate a new score for the identified transactions using the updated fraud scoring rules 218 in the rules database 216. Methods for scoring transactions using fraud scoring rules will be apparent to persons having skill in the relevant art. In step 416, the processing unit 204 may identify if fraud is indicated for each transaction using the newly calculated score. If fraud is not indicated, then the process 400 may be completed. If fraud is indicated, then, in step 418, the processing unit 204 may process the transactions indicative of fraud accordingly using methods and systems that will be apparent to persons having skill in the relevant art.

### Exemplary Method for Improving Fraud Scoring Based on Criminal Activity

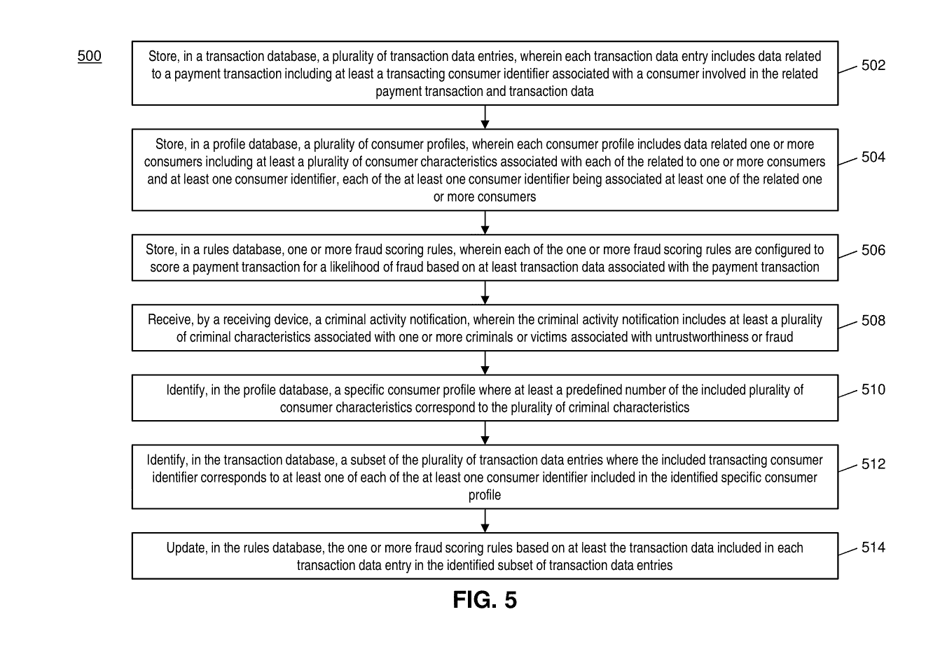

FIG. 5 illustrates a method 500 for the improving of fraud scoring based on criminal activity.

In step 502, a plurality of transaction data entries (e.g., transaction data entries 210) may be stored in a transaction database (e.g., the transaction database 208), wherein each transaction data entry 210 includes data related to a payment transaction including at least a transacting consumer identifier associated with a consumer involved in the related payment transaction and transaction data. In some embodiments, the transaction data may include at least one of: a transaction amount, product data, transaction time and/or date, geographic location, coupon data, merchant data, consumer data, and point-of-sale identifier. In one embodiment, each transaction data entry 210 may further include a merchant identifier associated with a merchant involved in the related payment transaction.

In step 504, a plurality of consumer profiles (e.g., consumer profiles 214) may be stored in a profile database (e.g., the consumer database 212), wherein each consumer profile 214 includes data related to one or more consumers including at least a plurality of consumer characteristics associated with each of the related one or more consumers and at least one consumer identifier, each of the at least one consumer identifier being associated with at least one of the related one or more consumers. In some embodiments, the plurality of consumer characteristics may include at least one of: age, gender, income, marital status, familial status, residential status, occupation, education, zip code, postal code, street address, county, city, state, country, spending behavior, purchase behavior, and trade area.

In step 506, one or more fraud scoring rules (e.g., fraud scoring rules 218) may be stored in a rules database (e.g., the rules database 216), wherein each of the one or more fraud scoring rules 218 are configured to score a payment transaction for a likelihood of fraud based on at least transaction data associated with the payment transaction. In step 508, a criminal activity notification may be received by a receiving device (e.g., the receiving unit 202), wherein the criminal activity notification includes at least a plurality of criminal characteristics associated with one or more criminals or victims associated with untrustworthiness or fraud. In one embodiment, the plurality of consumer characteristics and plurality of criminal characteristics may not be personally identifiable.

In step 510, a specific consumer profile 214 in the profile database 212 may be identified where at least a predefined number of the included plurality of consumer characteristics corresponds to the plurality of criminal characteristics. In step 512, a subset of the plurality of transaction data entries 210 may be identified in the transaction database 208 where the included transacting consumer identifier corresponds to at least one of each of the at least one consumer identifier included in the identified specific consumer profile 214.

In step 514, the one or more fraud scoring rules 218 may be updated in the rules database 216 based on at least the transaction data included in each transaction data entry 210 in the identified subset of transaction data entries 210. In one embodiment, updating the one or more fraud scoring rules may be further based on the plurality of criminal characteristics included in the received criminal activity notification. In some embodiments, each of the one or more fraud scoring rules 218 may include an algorithm, and updating the one or more fraud scoring rules 218 may include modifying the algorithm included in at least one of the one or more fraud scoring rules 218 based on at least the transaction data included in each transaction data entry 210 in the identified subset of transaction data entries 210.

In one embodiment, the method 500 may further include generating, by a processing device (e.g., the processing unit 204), a new fraud scoring rule 218 based on at least the transaction data included in each transaction data entry 210 in the identified subset of transaction data entries 210, wherein updating the one or more fraud scoring rules 218 includes storing the generated new fraud scoring rule 218 in the rules database 216.

In some embodiments, the method 500 may further include: generating, by the processing device 204, new fraud scores for payment transaction related to a secondary set of transaction data entries 210 of the plurality of transaction data entries 210 by application of the updated one or more fraud scoring rules 218; and identifying, by the processing device 204, at least one of the transaction data entries 210 in the secondary set as indicative of fraud based on the generated new fraud scores. In a further embodiment, each of the transaction data entries 210 included in the secondary set are not included in the subset of transaction data entries 210.

### Computer System Architecture

FIG. 6 illustrates a computer system 600 in which embodiments of the present disclosure, or portions thereof, may be implemented as computer-readable code. For example, the processing server 104 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, 4, and 5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3A, 3B, 4, and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for improving fraud scoring based on criminal activity. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

1. A method for improving fraud scoring based on criminal activity, comprising:
storing, in a transaction database, a plurality of transaction data entries, wherein each transaction data entry includes data related to a payment transaction including at least a transacting consumer identifier associated with a consumer involved in the related payment transaction and transaction data;
storing, in a profile database, a plurality of consumer profiles, wherein each consumer profile includes data related to one or more consumers including at least a plurality of consumer characteristics associated with each of the related one or more consumers and at least one consumer identifier, each of the at least one consumer identifier being associated at least one of the related one or more consumers;
storing, in a rules database, one or more fraud scoring rules, wherein each of the one or more fraud scoring rules are configured to score a payment transaction for a likelihood of fraud based on at least transaction data associated with the payment transaction;
receiving, by a receiving device, a criminal activity notification, wherein the criminal activity notification includes at least a plurality of criminal characteristics associated with one or more criminals or victims associated with untrustworthiness or fraud;
identifying, in the profile database, a specific consumer profile where at least a predefined number of the included plurality of consumer characteristics correspond to the plurality of criminal characteristics;
identifying, in the transaction database, a subset of the plurality of transaction data entries where the included transacting consumer identifier corresponds to at least one of each of the at least one consumer identifier included in the identified specific consumer profile; and
updating, in the rules database, the one or more fraud scoring rules based on at least the transaction data included in each transaction data entry in the identified subset of transaction data entries.

2. The method of claim 1, further comprising:
generating, by a processing device, a new fraud scoring rule based on at least the transaction data included in each transaction data entry in the identified subset of transaction data entries, wherein
updating the one or more fraud scoring rules includes storing the generated new fraud scoring rule in the rules database.

3. The method of claim 1, wherein
each of the one or more fraud scoring rules includes an algorithm, and
updating the one or more fraud scoring rules includes modifying the algorithm included in at least one of the one or more fraud scoring rules based on at least the transaction data included in each transaction data entry in the identified subset of transaction data entries.

4. The method of claim 1, wherein the plurality of consumer characteristics includes at least one of: age, gender, income, marital status, familial status, residential status, occupation, education, zip code, postal code, street address, county, city, state, and country.

5. The method of claim 1, wherein each transaction data entry further includes a merchant identifier associated with a merchant involved in the related payment transaction.

6. The method of claim 1, wherein the transaction data includes at least one of: a transaction amount, product data, transaction time and/or date, geographic location, coupon data, merchant data, consumer data, and point-of-sale identifier.

7. The method of claim 1, wherein the plurality of consumer characteristics and criminal characteristics are not personally identifiable.

8. The method of claim 1, further comprising:
generating, by a processing device, new fraud scores for payment transactions related to a secondary set of transaction data entries of the plurality of transaction data entries by application of the updated one or more fraud scoring rules; and
identifying, by the processing device, at least one of the transaction data entries in the secondary set as indicative of fraud based on the generated new fraud scores.

9. The method of claim 8, wherein each of the transaction data entries included in the secondary set are not included in the subset of transaction data entries.

10. The method of claim 1, wherein the updating of the one or more fraud scoring rules is further based on the plurality of criminal characteristics included in the received criminal activity notification.

11. A system for improving fraud scoring based on criminal activity, comprising:
a transaction database configured to store a plurality of transaction data entries, wherein each transaction data entry includes data related to a payment transaction including at least a transacting consumer identifier associated with a consumer involved in the related payment transaction and transaction data;
a profile database configured to store a plurality of consumer profiles, wherein each consumer profile includes data related to one or more consumers including at least a plurality of consumer characteristics associated with each of the related one or more consumers and at least one consumer identifier, each of the at least one consumer identifier being associated at least one of the related one or more consumers;
a rules database configured to store one or more fraud scoring rules, wherein each of the one or more fraud scoring rules are configured to score a payment transaction for a likelihood of fraud based on at least transaction data associated with the payment transaction;
a receiving device configured to receive a criminal activity notification, wherein the criminal activity notification includes at least a plurality of criminal characteristics associated with one or more criminals or victims associated with untrustworthiness or fraud; and
a processing device configured to
identify, in the profile database, a specific consumer profile where at least a predefined number of the included plurality of consumer characteristics correspond to the plurality of criminal characteristics,
identify, in the transaction database, a subset of the plurality of transaction data entries where the included transacting consumer identifier corresponds to at least one of each of the at least one consumer identifier included in the identified specific consumer profile, and
update, in the rules database, the one or more fraud scoring rules based on at least the transaction data included in each transaction data entry in the identified subset of transaction data entries.

12. The system of claim 11, wherein
the processing device is further configured to generate a new fraud scoring rule based on at least the transaction data included in each transaction data entry in the identified subset of transaction data entries, and
updating the one or more fraud scoring rules includes storing the generated new fraud scoring rule in the rules database.

13. The system of claim 11, wherein
each of the one or more fraud scoring rules includes an algorithm, and
updating the one or more fraud scoring rules includes modifying the algorithm included in at least one of the one or more fraud scoring rules based on at least the transaction data included in each transaction data entry in the identified subset of transaction data entries.

14. The system of claim 11, wherein the plurality of consumer characteristics includes at least one of: age, gender, income, marital status, familial status, residential status, occupation, education, zip code, postal code, street address, county, city, state, and country.

15. The system of claim 11, wherein each transaction data entry further includes a merchant identifier associated with a merchant involved in the related payment transaction.

16. The system of claim 11, wherein the transaction data includes at least one of: a transaction amount, product data, transaction time and/or date, geographic location, coupon data, merchant data, consumer data, and point-of-sale identifier.

17. The system of claim 11, wherein the plurality of consumer characteristics and criminal characteristics are not personally identifiable.

18. The system of claim 11, wherein the processing device is further configured to
generate new fraud scores for payment transactions related to a secondary set of transaction data entries of the plurality of transaction data entries by application of the updated one or more fraud scoring rules, and
identify at least one of the transaction data entries in the secondary set as indicative of fraud based on the generated new fraud scores.

19. The system of claim 18, wherein each of the transaction data entries included in the secondary set are not included in the subset of transaction data entries.

20. The system of claim 11, wherein the updating of the one or more fraud scoring rules is further based on the plurality of criminal characteristics included in the received criminal activity notification.

21. The method of claim 1, wherein the criminal activity notification includes at least a plurality of criminal characteristics associated with one or more criminals and one or more victims associated with untrustworthiness or fraud.

22. The system of claim 11, wherein the criminal activity notification includes at least a plurality of criminal characteristics associated with one or more criminals and one or more victims associated with untrustworthiness or fraud.
